(19) United States
(12) Patent Application Publication
(10) Pub. No.: US 2026/0292705 A1
(43) Pub. Date: Sep. 24, 2026

(54) ASSESSING AND ENFORCING MODULE COMPATIBILITY IN A MODULAR NETWORK SWITCH SYSTEM

(71) Applicant: Arista Networks, Inc., Santa Clara, CA (US)

(72) Inventors: Mpho Mbotho, North Vancouver (CA); Cooper Harasyn, Vancouver (CA); Justin Oliver, White Rock (CA); Aaron Payment, Coquitlam (CA)

(21) Appl. No.: 19/088,917

(22) Filed: Mar. 24, 2025

(51) Int. Cl. H04W 52/22; H04L 41/0663

(52) U.S. Cl. CPC H04W 52/22; H04L 41/0663

(57) ABSTRACT

A modular network switch performs a compatibility assessment to enforce compatibility between installed modules. Upon startup or upon detecting insertion of a new module, a supervisor module obtains respective module identifiers for the set of installed modules. The supervisor module performs, based on the compatibility information and the respective module identifiers, a compatibility assessment between the set of modules to detect a compatible module set. The supervisor module then sends a control signal to disable power to switching components of one or more incompatible modules and enable power to switching components of modules in the compatible module set. A similar compatibility assessment may be performed in a network switch device of a switch aggregation group (SWAG) to assess and enforce compatibility with respect to the set of devices in the SWAG.

### BACKGROUND

Network data center environments rely on a variety of networking solutions to ensure efficient and scalable interconnectivity between numerous servers, storage devices, and other infrastructure components. Among these solutions, modular switches are a common component of the network fabric. A modular switch typically includes a chassis with module slots that can accommodate different types of modular cards that perform switching, management, and/or control functions. The modular architecture enables different combinations of modular cards to be inserted or removed to accommodate a variety of different configurations, to enable rapid replacement of failed components without significant downtime, and to enable scaling of network capacity as requirements grow.

### BRIEF DESCRIPTION OF THE DRAWINGS

The teachings of the embodiments herein can be readily understood by considering the following detailed description in conjunction with the accompanying drawings.

FIG. 1 illustrates an example of a network environment including a modular switch that includes compatibility assessment logic for enforcing compatibility between modules.

FIG. 2 illustrates an example of compatibility assessment logic for a modular switch that evaluates compatibility of installed modules.

FIG. 3 is a flowchart illustrating an example process for resolving incompatibilities between a set of installed modules in a modular switch.

FIG. 4 is a diagram illustrating an example technique for enforcing compatibility between modules in a modular switch.

FIG. 5 is a flowchart illustrating an example process for performing a compatibility evaluation associated with a set of modules in a modular switch.

FIG. 6 illustrates an example of a network environment including a switch aggregation group (SWAG) that includes compatibility assessment logic for enforcing compatibility between member switch devices.

### DETAILED DESCRIPTION

A modular network switch performs a compatibility assessment to enforce compatibility between installed modules. The modular network switch includes a chassis with a power supply, a power distribution system for distributing power from the power supply to a plurality of module slots, and a data interconnect for communicatively coupling the plurality of module slots. A set of modules inserted in the module slots includes at least one supervisor module, at least one fabric module, and a plurality of line card modules. Upon startup or upon detecting insertion of a new module, the supervisor module obtains respective module identifiers for the set of modules indicative of a model, firmware version, or other information from which interoperability can be derived. Compatibility assessment logic (which may be implemented by a supervisor module) obtains the respective module identifiers for the set of inserted modules and performs a compatibility assessment to detect a compatible module set. The compatibility assessment logic then sends a control signal to disable power to switching components and/or other operational components of one or more incompatible modules (and enable power to switching components and/or other operational components of the modules in the compatible module set). At startup of the modular network switch, this compatibility assessment may apply a priority list to determine which module to enable and which module to disable between an incompatible pair of modules. When a new module is inserted during operation, the compatibility assessment may enable switching components and/or other operational components of the new module only if it is compatible with all existing operational modules. The compatibility assessment and enforcement scheme enables operation of the modular network switch with low rate of failure or downtime even when modules are upgraded or otherwise replaced with modules having different models, firmware versions, or other operating characteristics that may potentially affect interoperability.

In another embodiment, a similar compatibility assessment and enforcement scheme may be performed in association with a set of network switch devices in a switch aggregation group (SWAG). Here, the assessment may be performed and enforced when the SWAG is activated or when a new network switch device is added to the SWAG. The compatibility assessment and enforcement scheme similarly ensures that the SWAG can operate with low rate of failure or downtime even in environments where member devices are frequently upgraded or otherwise changed.

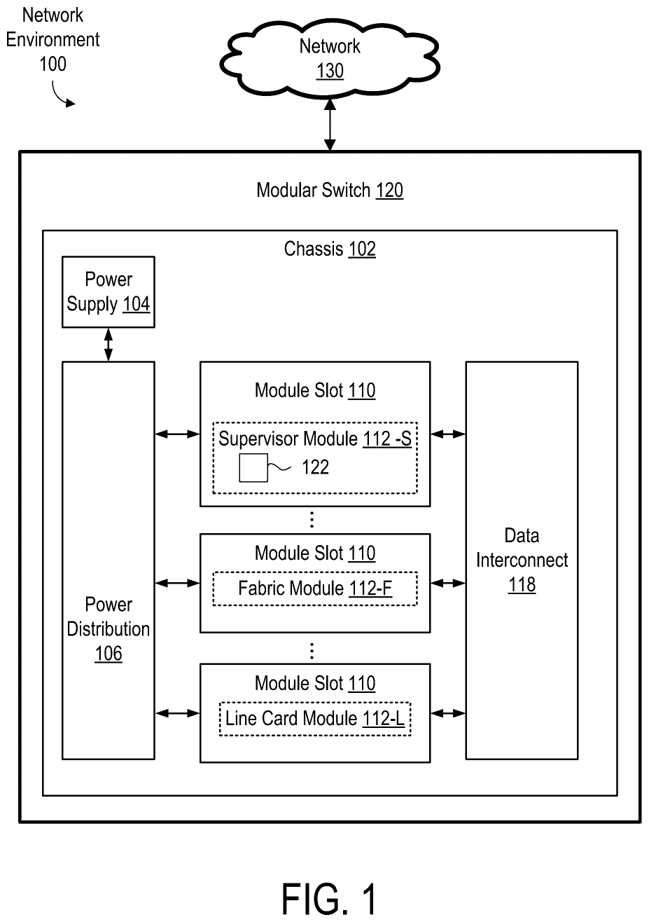

FIG. 1 illustrates an example embodiment of a modular switch 120 for a networking environment 100 such as a datacenter. The modular switch 120 includes a chassis 102, a power supply 104, a power distribution system 106, a data interconnect 118, and a plurality of module slots 110 that can accommodate one or more supervisor modules 112-S, one or more fabric modules 112-F, and one or more line card modules 112-L (generically referenced herein as modules 112). The various modules 112 may be swapped in or out to enable support for a wide variety of different configurations of the modular switch 120, to enable seamless upgrades to the modular switch 120, and to enable rapid replacement of failed modules 112 while avoiding downtime.

The chassis 102 provides a structural framework for the modular switch 120 and houses the power supply 104, power distribution system 106, data interconnect 118, and plurality of modular slots 110. The chassis 102 may furthermore include other supporting elements (not shown) such as a cooling system, one or more access panels, one or more digital display panels and/or indicator lights, or other components.

The power supply 104 supplies power to the module slots 110 and any inserted modules 112 via the power distribution system 106. The power supply 104 may perform various power conversions to convert incoming electrical power into the appropriate voltages and currents used by the modules 112. The power distribution system 106 may include power lines, connectors, and supporting components to supply power from the power supply 104 to the module slots 110.

The data interconnect 118 comprises an internal network of data lines, connectors, or supporting components (e.g., in the form of a backplane or midplane) for facilitating data transfer internally between inserted modules 112 and/or for facilitating data transfer externally between the inserted modules 112 and an external network 130. The data interconnect 118 may alternatively include one or more cables (e.g., Ethernet cables) that are not necessarily integrated into the chassis 102.

The module slots 110 are structured to receive respective modules 112. The slots 110 may include mechanical and/or electronic elements for detecting when a module 112 is present or not present in the slot 110, and may provide data and power connectivity to an inserted module 112 when the module 112 is present. For example, modules 112 may have card-like form factors that slide into respective slots 110 having reciprocal form factors. The module slots 110 may be of a uniform structure and connectivity configuration such that each module slot 110 can accept different types of modules 112 (which are similarly structured to have standardized form factors and connectivity configurations). For example, in one implementation, any given slot 110 may be physically structured to accept a compatible supervisor module 112-S, a fabric module 114-F, or a line card module 116-L. In other implementations, the modular switch 120 may include one or more module slots 110 that are designed to only accept a specific type of module 112 (e.g., based on structural and/or electronic constraints). For example, a module slot 110 may be dedicated to support either supervisor modules 112-S, fabric modules 112-F, or line card modules 112-L.

In one implementation, the module slots 110 and corresponding modules 112 are designed for plug-and-play operation such that a compatible module 112 may be inserted or removed and begin operating without requiring a reset or manual reconfiguration of the modular switch 120. Furthermore, currently operating modules 112 may continue to operate without interruption when modules 112 are inserted or removed.

The different types of modules 112 may differ in their hardware and/or software configurations to perform different functions associated with the overall operation of the modular switch 120. A supervisor module 112-S is configured to provide general management and control functions of the modular switch 120. For example, the supervisor module 112-S may perform functions such as configuring and enforcing system settings, configuring routing protocols, and configuring and enforcing network policies. The fabric module 112-F operates as an internal interconnect between the line card modules 112-L within the modular switch 120. In some implementations, the fabric module 112-F may also include an integrated fan assembly to provide cooling to the modular switch 120. The line card modules 112-L operate as the primary external interfaces of the modular switch 120 and perform network switching functions. Each line card module 112-L may include multiple external ports for connecting to servers, storage devices, or other networking equipment. Different types of line card modules 112-L may support different interface types, (such as Ethernet or fiber) and may have different port densities and different operating specifications (e.g., throughput, latency, etc.). Some line card modules 112-L may include advanced networking capabilities such as packet filtering, traffic shaping, encryption, etc.

In operation, the various modules 112 of the modular switch 120 may operate in coordination such that the modular switch 120 logically functions like a single switch device. The modular architecture enables a wide variety of configurations dependent on desired operating specifications.

Various implementations of the modular switch 120 may include certain constraints on the combinations of modules 112 that are interoperable. For example, in one implementation, the modular switch 120 only operates when there is at least one supervisor module 112, at least one fabric module 114, and at least one line card module 116. The constraints may furthermore limit the maximum number of modules 112 of a specific type (e.g., limiting the configuration to up to two supervisor modules 112-S).

Modules 112 of the same general type (e.g., supervisor module 112-S, fabric module 112-F, line card module 112-L) may be available in different models, versions, generations, firmware and/or software revisions, or other characteristics that may affect interoperability with other modules 112. For example, some older models of modules 112 may be incompatible with certain newer models of the same or different type. Furthermore, different models may have differing operating protocols, operating features, or other characteristics that render them operationally incompatible with each other in the same modular switch 120. In some instances, a pair of modules 112 may be deemed incompatible based on conducted tests and observations of operational failures. In other instances, a pair of modules 112 may be deemed incompatible based on an administrative decision, whether or not interoperability is actually tested.

To avoid failures due to incompatibilities, the modular switch 120 may include compatibility assessment logic 122 that detects and resolves incompatibilities. In the illustrated implementation, the compatibility assessment logic 122 may operate as a component of an installed supervisor module 112-S. In other embodiments, the compatibility assessment logic 122 may be a component of a different type of module 112 or may be integrated separately in the chassis 102.

The compatibility assessment logic 122 generally operates to identify the set of modules 112 installed in the modular switch 120, perform a compatibility assessment of the set of installed modules 112, and control enabling or disabling of the respective modules 112 or components thereof to avoid incompatibilities. In one implementation, the compatibility assessment logic 122 may enforce compatibility by generating power control signals to turn on or off power to switching components or other operational components of respective modules 112 based on the compatibility assessment. Here, each module 112 receives a respective power control signal and enables or disables power to one or more components (e.g., via an on-module power switch or configuration setting). For example, the power control signal may enable or disable power to switching components of a line card module 112-L or fabric module 112-F. The power control signal may also control enabling or disabling power to other operational components that are not necessarily directly related to switching such as supervisory functions of a supervisor module 112-S. When disabled, the module 112 may operate in a low power state in which it may receive and process power control signals and/or other high level control signals, but the disabled module 112 does not perform switching, supervisory operations, or other functions that affect its compatibility with other modules 112. In other implementations, the module slots 110 or the power distribution system 106 may include respective power connectors per slot that may be enabled or disabled based on respective power control signals to control power to an inserted module 112. Alternatively, the compatibility assessment logic 122 may disable or enable incompatible modules based on a configuration setting without necessarily controlling power to the module 112.

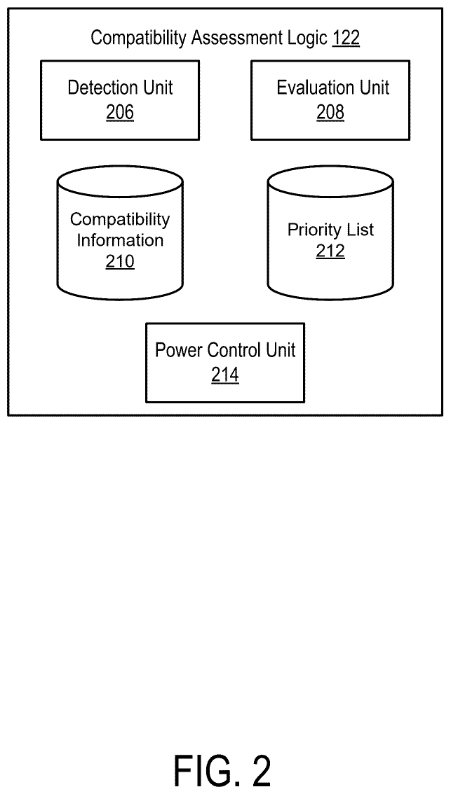

To assess compatibility, the compatibility assessment logic 122 may obtain respective module identifiers for each installed module 112 that identifies characteristics relevant for assessing interoperability, such as the type of module (e.g., supervisor module 112-S, fabric module 112-F, or line card module 112-L), model, version, generation, operating characteristic, or other information affecting interoperability. The compatibility assessment logic 122 may perform the compatibility assessment based on stored compatibility information (e.g., a compatibility matrix that identifies a set of compatible module identifiers for each module identifier) and a priority list that specifies a priority order. Upon startup of the modular switch 120, the compatibility assessment logic 122 may iteratively check compatibility in accordance with the priority order (starting with the highest priority module) and disable the lower priority module in any incompatible pair. The compatibility assessment logic 122 may also perform a compatibility check upon detecting a newly inserted module 112 during operation and enable the newly inserted module 112 only if it is compatible with all currently operating modules 112. An example architecture and operating processes associated with the compatibility assessment logic 122 is further described below with respect to FIGS. 2-5.

The network 130 may include a local area network (LAN), one or more wide area networks (WAN), or a combination thereof. For example, the network 130 may include a LAN that locally couples a set of modular switches 120 within the network environment 100 together with other devices such as servers, storage devices, network monitoring appliances, firewall devices, etc. The network 130 may also include a wide area network (WAN) such as the Internet. In an example network environment 100, there may be multiple interconnected modular switches 120.

FIG. 2 illustrates an example embodiment of compatibility assessment logic 122 for a modular switch 120. In an example implementation, the compatibility assessment logic 122 includes a detection unit 206, an evaluation unit 208, a power control unit 214, a compatibility information store 210, and a priority list store 212. Other implementations of the compatibility assessment logic 122 may include different or additional components.

The detection unit 206 detects module identifiers for modules 112 installed in the module slots 110 of the modular switch 120. The module identifiers may uniquely identify characteristics of the corresponding modules 112 sufficient for determining compatibility. For example, the module identifiers may be indicative of the type of module 112 (such as a supervisor module 112-S, fabric module 112-F, or line card module 112-L), the model, revision number, or other characteristic. In one implementation, the detection unit 206 may automatically receive the module identifier from an installed module 112 when the installed module 112 is first inserted or when the modular switch 120 powers on or restarts. The module identifier may be stored to a non-volatile storage of the module 112 that may be read by the detection unit 206 when the module 112 is connected.

The compatibility information store 210 stores compatibility information associated with a set of module identifiers. In one implementation, the compatibility information may include, for each unique module identifier, a respective compatibility list that lists compatible module identifiers. In this implementation, the compatibility information store 210 uses a whitelist in which only compatible module identifiers are listed and unlisted module identifiers are presumed to be incompatible. In other implementations, the compatibility information may be stored as a blacklist of incompatible modules, or as a combined whitelist and blacklist. For example, in one implementation, compatibility may be expressed as a two-dimensional array that includes a row and a column for each known module identifier. The two-dimensional position within the array may store a value indicative of whether a pair of module identifiers corresponding to the row and column are compatible or incompatible.

The priority list store 212 stores an ordered list of module identifiers. The priority order may be used to determine the order of an iterative compatibility check performed at power on or reset (starting with the highest priority module) and controls which module 112 in an incompatible pair is given priority (i.e., will be enabled) between an incompatible pair. In one implementation, supervisor modules 112-S are generally given higher priority than fabric modules 112-F and line card module 112-L to ensure that at least one supervisor module 112-S is enabled. Furthermore, newer models or revisions of modules 112 may have higher priority than older models or revisions. However, the priority list may be established by an administrator based on any arbitrary priority ordering criteria desirable for maintaining compatibility within a given network environment.

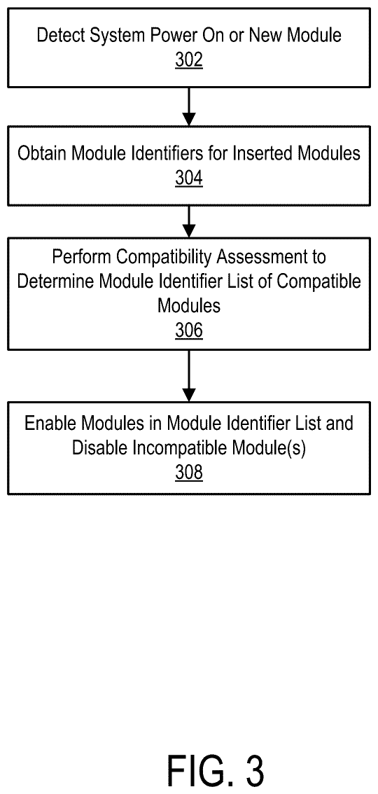

The evaluation unit 208 evaluates compatibility of the installed modules 112 based on the set of detected modules 112 from detection unit 206, the compatibility information from the compatibility information store 210, and the priority information from the priority list store 212. While different algorithms may be employed to perform this compatibility information, the evaluation unit 208 generally operates to detect any incompatibilities between pairs of modules 112 and determine, for each pair of incompatible modules 112, which of the modules 112 to enable and which to disable to resolve the incompatibility. At initial startup of the modular switch 120, the compatibility assessment and decisions may be based in part on the priority list. For example, starting with the highest priority module installed, the evaluation unit 208 may detect and mark as incompatible all lower priority modules that are not compatible. The evaluation unit 208 may then proceed to iteratively perform similar checks for remaining modules 112 in the priority order. When a new module 112 is inserted while the modular switch 120 is already powered on and operating, the evaluation unit 208 may treat all of the already installed modules 112 as having higher priority than the newly installed module 112, such that newly installed module 112 is only enabled if it is compatible with all currently operating modules 112. Because the evaluation unit 208 may apply different compatibility rules when the modular switch 120 is powered on and when a new module is inserted during operation, there may be situations where the set of enabled and disabled modules 112 changes upon restart on the modular switch 120. For example, if a newly inserted module A is incompatible with an existing module B, the newly inserted module A may be disabled and the existing module B is allowed to continue operating, even if module A has higher priority in the priority list store 212 than module B. However, upon reset, the recently inserted module A may instead become enabled and the lower priority module B may be disabled. Example processes for evaluating compatibility are further described below with respect to FIGS. 3-5.

The power control unit 214 generates the power control signals to enable or disable power to respective modules 112 (or specific components thereof) depending on the output from the evaluation unit 208. In one implementation, the power control unit 214 may put disabled modules in a low power or sleep state without necessarily fully disconnecting power as described above. For example, the power distribution system 106 may automatically supply an “always on” power to module slots 110 that is sufficient to enable reading of the module identifier of an installed module and receive the power control signals without fully enabling the module 112. Full power to enable operation may be turned on for modules 112 deemed compatible following the compatibility evaluation described herein. In other implementations, the compatibility assessment logic 122 may enable or disable modules 112 using a logical configuration setting without necessarily physically coupling or decoupling power to the modules 112.

The compatibility assessment logic 122 may be implemented as a set of instructions stored to a non-transitory computer-readable storage medium. The instructions are executed by one or more processors to carry out the functions attributed to the respective components of the compatibility assessment logic 122 described herein. In other implementations, the compatibility assessment logic 122 may be implemented wholly or partly using digital logic of a field programmable gate array (FPGA) or application-specific integrated circuit (ASIC).

FIG. 3 is a flowchart illustrating an example embodiment of a process for performing a compatibility evaluation for a set of modules 112 installed in a modular switch 120. The evaluation unit 208 detects 302 a system power on event (e.g., when powered on from an off state or upon reset of the modular switch 120) or insertion of a new module in a module slot 110. The evaluation unit 208 obtains 304 module identifiers for the inserted modules 112. On a power on event, this step may involve reading the module identifiers from each of the inserted modules 112. In the case of a module 112 being newly installed while the modular switch 120 is operating, the step may involve reading the module identifier from the newly installed module 112 and adding it to a previously stored list of module identifiers for modules 112 that were previously detected and operating. The previously stored list may exclude module identifiers for modules 112 that are physically installed but disabled. The evaluation unit 208 then performs 306 a compatibility assessment for the set of module identifiers. The evaluation unit 208 may disable 308 modules 112 that are deemed incompatible with one or more higher priority modules. At power on or reset, this priority may be based on the priority order specified in the priority list store 212. When a module 112 is installed during operation, higher priority may instead automatically be given to the modules 112 that are already operating such that the newly installed module 112 is only enabled if it is compatible with all currently operating modules 112. Thus, the currently operating modules 112 are not disabled on the basis of incompatibility with a newly installed module 112. This technique reduces downtime associated with plug-and-play changes to the modular switch 120.

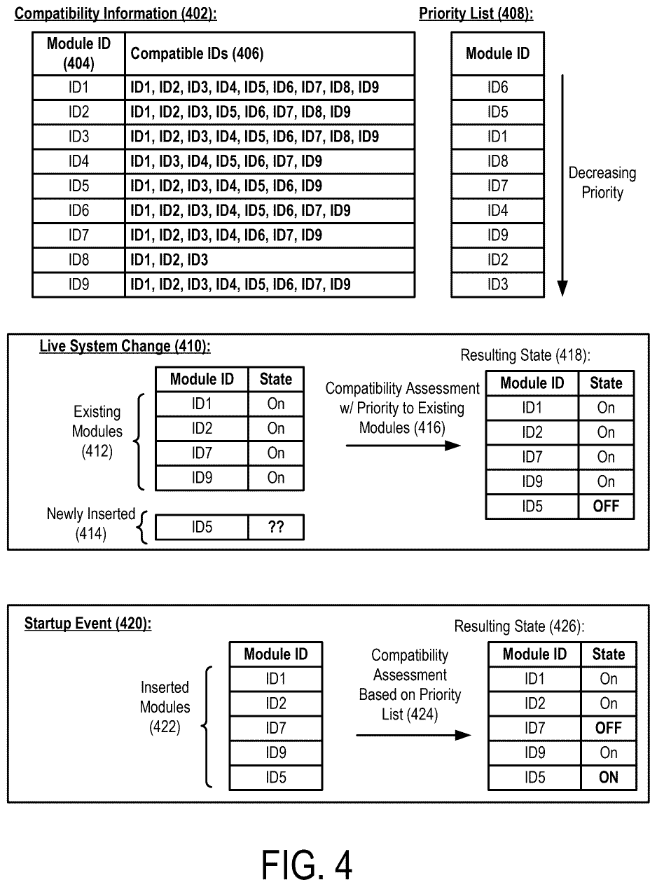

FIG. 4 illustrates an example of the above-described technique for enforcing compatibility in a modular switch 120. In this example, compatibility information 402 is stored that indicates a set of compatible module identifiers 406 compatible with each of a set of module identifiers 404. In this example, the compatibility information 402 is stored as a whitelist model. In other implementations, a blacklist model (or a combined whitelist and blacklist model) may be used to indicate the compatibility information 402. A priority list 408 indicates priority of the modules 112.

In a first example situation, the modular switch 120 enforces compatibility in response to a live system change 410 (e.g., when a new module is inserted in an executing system). In this example, the modular switch 120 is operating with existing modules {ID1, ID2,ID7, ID9} 412 and a newly inserted module ID5 414 triggers a compatibility assessment 416. The compatibility information 402 indicates an incompatibility between newly inserted module ID5 and existing module ID7. In this scenario, priority is given to the existing module ID7 that is already powered on and executing. Therefore, the newly inserted module ID5 414 is disabled and the existing modules {ID1, ID2, ID7, ID9) 412 remain enabled in the resulting power state 418.

In a second example situation the modular switch 120 enforces compatibility in response to a startup event 420 (e.g., a reset). The startup event triggers a new compatibility assessment 424, which this time bases priority on the preestablished priority list 408. In this scenario, module ID5 is given priority over incompatible module ID7 because module ID5 has higher priority in the priority list 408. Therefore, module ID5 becomes enabled while module ID7 is disabled in the resulting state 426. These examples illustrate that different resulting states 418, 426 may be reached depending on whether the compatibility assessment is triggered from a live system change 410 while the system is executing 410 or upon a startup event 420.

In a further example, a compatibility check may be performed when a module 112 is removed during operation. For example, if the module ID7 is removed when in the operating state 418, the module ID5 may then become enabled. Similarly, if the module ID5 is removed when in the operating state 426, the module ID7 may become enabled.

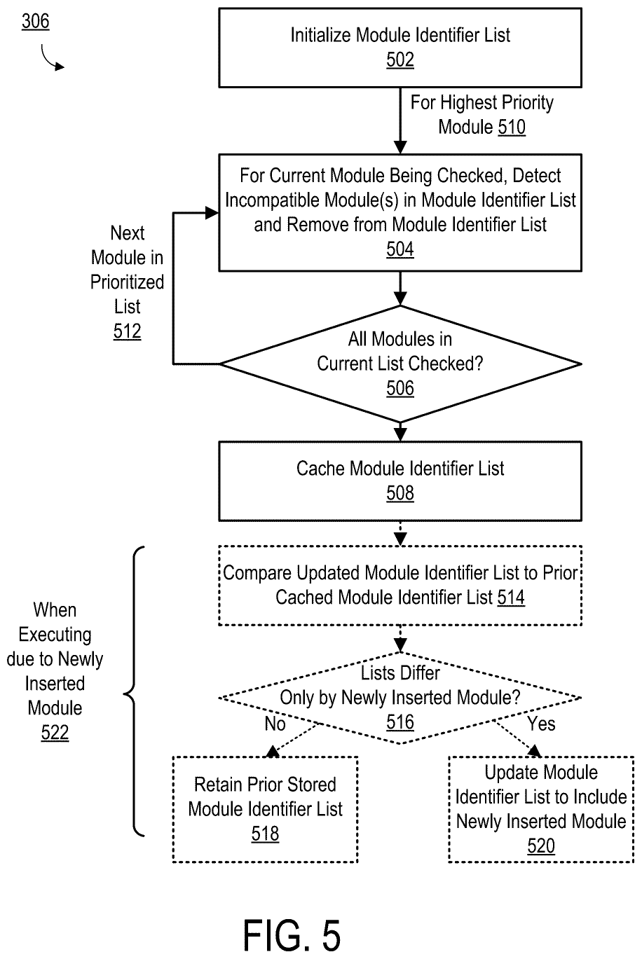

FIG. 5 is a flowchart illustrating one example algorithm for performing 306 the compatibility assessment. In this example, the compatibility assessment logic 122 initializes 502 a module identifier list that identifies an initial set of modules 112 for compatibility checking. At a power on event, the module identifier list may be initialized to include all unique module identifiers for installed modules 112. When the process is invoked upon detecting a new module 112 being inserted while the modular switch 120 is operational, the module identifier list may instead be initialized to include the newly inserted module 112 and a previously stored module list of the already installed and operating modules 112 (i.e., excluding modules that were disabled due to incompatibility). For example, the new module may be added to an initial module identifier list that was previously stored to generate an updated module identifier list that includes the new module. The compatibility assessment logic 122 then iteratively performs a set of steps for evaluating compatibility. Starting with the highest priority module 510 (e.g., as determined from the priority list store 212) in the module identifier list, the compatibility assessment logic 122 identifies 504 any module identifiers in the module identifier list that are incompatible with the module 112 currently being checked, and removes the identifiers for the incompatible modules 112 from the module identifier list. After each check, the compatibility assessment logic 122 determines 506 if there are more module identifiers to check, and if so, repeats 512 the above-described evaluation for the next highest priority module 112 remaining the module identifier list. Once all module identifiers have been checked in the priority order, the resulting module identifier list is stored 508. Using this process, the resulting module identifier list includes a compatible modular identifier set that includes modules 112 that are all mutually compatible.

The compatibility assessment logic 122 may execute additional steps 522 when performing the compatibility evaluation based on detection of a newly inserted module 112, which may be designed to ensure that existing operating modules 112 are not disabled (i.e., existing operating modules 112 take priority over the newly installed module 112 irrespective of their priorities in the priority list store 212). Here, the compatibility assessment logic 122 compares 514 the newly updated module identifier list with a prior stored module identifier list specifying the list of operating modules 112 that were present prior to insertion of the new module 112. The compatibility assessment logic 122 may then determine 516 if the addition of the newly inserted module 112 is the only difference between the lists. If the lists differ only by the addition of the newly inserted module 112, this represents a situation where the newly inserted module 112 is compatible with all previously executing modules 112. In this case, the compatibility assessment logic 122 stores 520 the updated module identifier list (that includes the newly inserted module 112) to be utilized in future compatibility assessments. Otherwise, if the updated module identifier list omits one or more module identifiers relative to the previously stored list, this indicates a situation where the newly inserted module 112 has some incompatibility with one or more of the previously executing modules. In this situation, the compatibility assessment logic 122 may retain 518 the previously stored module identifier list that excludes the newly inserted module 112. This step effectively ensures that priority is given to the previously operating modules 112 even if the newly inserted module 112 has higher priority in the priority list.

In cases where a newly inserted module has the same identifier (i.e., same model or other characteristics set) as an existing module, the compatibility assessment may be skipped and the module identifier list need not be updated. Here, the newly inserted module will be enabled if the module identifier is on the currently stored module identifier list of compatible modules and otherwise will be disabled. For example, in the example of FIG. 4 when the modular switch 120 is in the power state 418, if another module is newly inserted that has an identifier ID7 (identical to an existing module ID7 412 that is enabled), the compatibility assessment 416 may be skipped and the new module with identifier ID7 may be automatically enabled. If another module is newly inserted that has the identifier ID5 (identical to the existing module ID5 that is disabled), the compatibility assessment 416 may similarly be skipped and the new module with identifier ID5 may be automatically disabled.

FIG. 5 represents just one possible algorithm for performing the compatibility assessment step 306. The process of FIG. 5 enables an implementation that utilizes the same function (in steps 502-508) for both power up situations and newly inserted modules. In alternative implementations, separate functions may be stored and executed to perform respective evaluations upon power up and upon detecting a newly inserted module 112. For example, an evaluation function performed upon detecting a newly inserted module 112 may directly check whether the newly inserted module 112 is compatible with each existing operating module 112 (ignoring priority list in the priority list store 212), and add the newly inserted module 112 to the module identifier list if all compatibilities are confirmed. A separate evaluation function may be performed upon power-on according to steps 502-508 of FIG. 5, which rely on the priority list to determine which modules 112 are given priority for detected incompatible pairs.

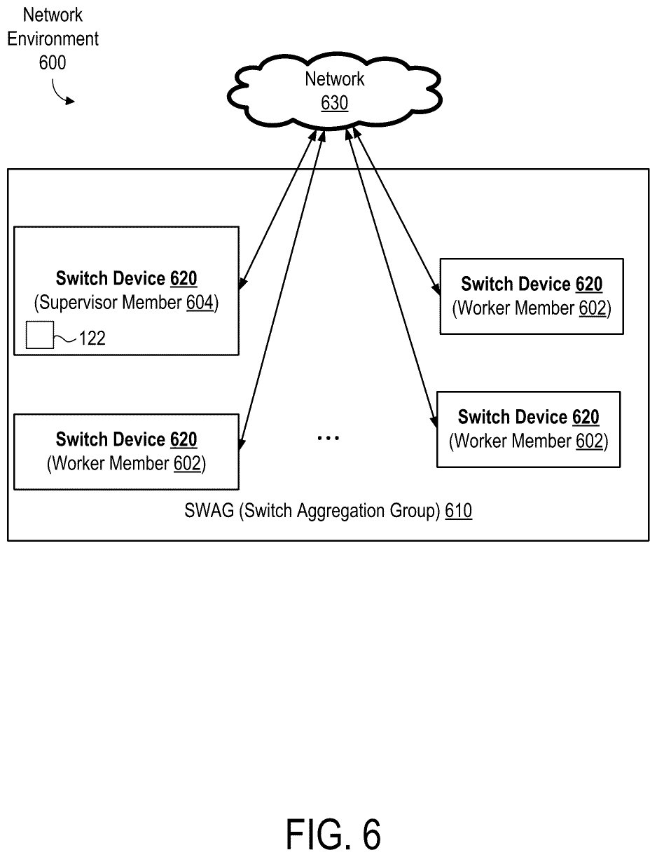

FIG. 6 illustrates another example of a network environment 600 where the above-described compatibility assessment logic 122 and corresponding processes (e.g., such as those shown in FIGS. 3-5) may operate. In this example, the compatibility assessment logic 122 is deployed in the context of a switch aggregation group (SWAG) 610. The SWAG 610 comprises a set of switch devices 620, which may each be individually configured as either a supervisor member 602 or a worker member 604 (e.g., configurable in software or firmware setting). The supervisor members 602 operate to perform orchestration and control functions, while the worker members 604 perform network switching functions under orchestration and control of the supervisor members 602.

The set of switch devices 620 in the SWAG 610 collectively operate as a single logical network switch associated with a network 630. Different SWAG 610 configurations can flexibly employ any number of supervisor members 602 and any number of worker members 604, thereby enabling high scalability and efficiency of the network switching functions. Unlike the modular switch 120 of FIG. 1, the switch devices 620 in the SWAG 610 may comprise standalone devices coupled via external cables and are not generally integrated into a physical chassis 102.

Similar to the modular switch 120 described above, operation of a SWAG 610 may be constrained by compatibility of its member switch devices 620, i.e., not all models and/or configurations of switch devices 620 are interoperable in a SWAG configuration. To prevent failures or other operating issues due to incompatibilities, the compatibilities of member switch devices 620 may be evaluated upon activation of the SWAG 610 or upon a device 620 being added to the SWAG 610. For example, the compatibility check may be performed when all of the switch devices 620 in the SWAG 610 are restarted, are first powered on, or when the devices 620 are first logically grouped to operate as a SWAG 610, analogously to the compatibility check performed upon startup of a modular switch 120. The compatibility check may additionally be performed when a new switch device 620 is added to the SWAG 610 (e.g., when a single switch device 620 comes online or is added to an existing operating SWAG 610) analogously to the compatibility check performed upon a new module 112 being inserted in a modular switch 120.

This compatibility assessment may be performed using the same techniques described herein for assessing compatibility of modules 112 of a modular switch 120. For example, compatibility assessment logic 122 may obtain device identifiers from the individual switch devices 620, detect incompatible pairs of devices 620, and determine based on device priority, which device 620 in an incompatible pair to enable or disable. Here, enabling or disabling devices may be performed by controlling power to the devices 620 and/or using a logical technique (e.g., by removing devices from the logic SWAG membership) without necessarily directly controlling power. Disabling a device 620 may include disabling switching components of the device, supervisory components of the device, or other functional components that affect interoperability. In one implementation, disabled devices 620 may still operate in a low power state to receive and process power control signals and/or perform other high-level functions that are not affected by incompatibility. In one implementation, the compatibility assessment logic 122 may be implemented in a supervisor member 602 of the SWAG 610.

In the network environment 600 of FIG. 6, the compatibility assessment logic 122 may be implemented as a set of instructions stored to a non-transitory computer-readable storage medium. The instructions are executed by one or more processors to carry out the functions attributed to the respective components of the compatibility assessment logic 122 described herein. In other implementations, the compatibility assessment logic 122 may be implemented wholly or partly using digital logic of a field programmable gate array (FPGA) or application-specific integrated circuit (ASIC).

Upon reading this disclosure, those of ordinary skill in the art will appreciate still alternative structural and functional designs and processes for the described embodiments, through the disclosed principles of the present disclosure. Thus, while particular embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure herein without departing from the scope of the disclosure as defined in the appended claims.

What is claimed is:

1. A modular network switch comprising:
a chassis including a power supply, a power distribution system for distributing power from the power supply to a plurality of module slots, and a data interconnect for communicatively coupling the plurality of module slots;
a set of modules inserted in the plurality of module slots, the set of modules including:
a plurality of line card modules to perform processing of network traffic communicated via external connections;
at least one fabric module to facilitate internal data transfers between the plurality of line card modules; and
at least one supervising module to provide control and management for the plurality of line card modules and the at least one fabric module, the at least one supervising module including:
a processor; and
a storage medium to store compatibility information associated with a set of module identifiers, and to store instructions executable by the processor for enforcing compatibility between the set of modules, the instructions when executed causing the processor to perform steps including:
obtaining respective module identifiers for the set of modules;
performing, based on the compatibility information and the respective module identifiers for the set of modules, a compatibility assessment between the set of modules to detect a compatible module set of the set of modules; and
sending a power control signal to disable power to switching components of one or more incompatible modules absent from the compatible module set.

2. The modular network switch of claim 1, further comprising sending a control signal to enable power to the switching components of the compatible module set.

3. The modular network switch of claim 1, wherein performing the compatibility assessment occurs upon detecting a power on event or restart event of the modular network switch.

4. The modular network switch of claim 3, wherein performing the compatibility assessment comprises:
obtaining a priority list comprises an ordered set of module identifiers; and
determining from the compatibility information a pair of incompatible modules; and
determining, based on the priority list, a lower priority module of the pair of incompatible modules; and
omitting the lower priority module from the compatible module set.

5. The modular network switch of claim 1, wherein performing the compatibility assessment occurs upon detecting insertion of a new module during operation of the modular network switch.

6. The modular network switch of claim 5, wherein performing the compatibility assessment comprises:
determining from the compatibility information, if the new module is incompatible with any existing operating modules in the set of modules;
including the new module in the compatible module set if the new module is compatible with all of the existing operating modules; and
omitting the new module from the compatible module set if the new module is incompatible with any of the existing operating modules.

7. The modular network switch of claim 1, wherein performing the compatibility assessment occurs upon detecting insertion of a new module during operation of the modular network switch, wherein performing the compatibility assessment comprises:
determining from the compatibility information, if the new module is incompatible with an existing module that is enabled when the new module is inserted, and omitting the new module from the compatible module set to cause disabling of the power to switching components of the new module if the new module is incompatible with the existing module;
wherein the storage medium further includes instructions causing the processor to perform steps including:
performing a subsequent compatibility assessment upon reset of the modular network switch, wherein the subsequent compatibility assessment includes:
obtaining a priority list comprising an ordered set of module identifiers;
determining, based on the priority list, that the new module has higher priority than the existing module; and
sending a subsequent power control signal to enable power to the switching component of the new module and disable power to switching components of the existing module.

8. The modular network switch of claim 1, wherein obtaining the respective module identifiers for the set of modules comprises reading the respective module identifiers from a non-volatile storage of the set of modules.

9. The modular network switch of claim 1, wherein compatibility information comprises a whitelist indicating pairs of compatible module identifiers.

10. A method for operating a modular network switch, the method comprising:
detecting a system power on or restart event of the modular network switch;
obtaining respective module identifiers for a set of modules installed in the modular network switch;
initializing an initial module identifier list to include all of the respective module identifiers;
performing, based on compatibility information, a compatibility assessment between the respective module identifiers to detect one or more incompatibilities in the set of modules;
iteratively performing, in priority order based on a priority list, updates to the initial module identifier list to generate a compatible module identifier list that includes only mutually compatible modules;
storing the compatible module identifier list; and
sending a control signal to enable power to switching components of modules in the compatible module identifier list and disable power to switching components of modules excluded from the compatible module identifier list.

11. The method of claim 10, further comprising:
detecting, while the modular network switch is operational, insertion of a new module into a module slot of the modular network switch;
determining if the new module is incompatible with any existing modules in the compatible module identifier list;
disabling switching components of the new module if the new module is incompatible with any of the existing modules in the compatible module identifier list; and
enabling switching components of the new module if the new module is compatible with all of the existing modules in the compatible module identifier list.

12. The method of claim 10, further comprising:
detecting, while the modular network switch is operational, insertion of a new module into a module slot of the modular network switch;
adding the new module to the compatible module identifier list to generate a first updated module identifier list;
reperforming the compatibility assessment based on the compatibility information and the first updated module identifier list and updating the first updated module identifier list to generate a second updated module identifier list;
performing a comparison of the compatible module identifier list and the second updated module identifier list;
based on the comparison, determining if the new module is an only difference between the compatible module identifier list and the second updated module identifier list;
enabling switching components of the new module and storing the first updated module identifier list if the new module is the only difference; and
disabling switching components of the new module and storing the compatible module identifier list if the new module is not the only difference.

13. The method of claim 10, wherein obtaining the respective module identifiers for the set of modules comprises reading the respective module identifiers from a non-volatile storage of the set of modules.

14. A network switch device for a switch aggregation group comprising a set of network switch devices, the network switch device comprising:
switching logic for performing network switching in coordination with the switch aggregation group;
a processor; and
a storage medium to store compatibility information associated with a set of device identifiers, and to store instructions executable by the processor for enforcing compatibility between the set of network switch devices in the switch aggregation group, the instructions when executed causing the processor to perform steps including:
obtaining respective device identifiers for the set of network switch devices;
performing, based on the compatibility information and the respective device identifiers for the set of network switch devices, a compatibility assessment between the set of network switch devices to detect a compatible device set of the set of network switch devices; and
disabling switching components of one or more incompatible network switch devices that are absent from the compatible device set.

15. The network switch device of claim 14, further comprising enabling switching components of network switch devices in the compatible device set.

16. The network switch device of claim 14, wherein performing the compatibility assessment occurs upon detecting activation of the switch aggregation group.

17. The network switch device of claim 16, wherein performing the compatibility assessment comprises:
obtaining a priority list comprising an ordered set of device identifiers; and
determining from the compatibility information, a pair of incompatible devices; and
determining, based on the priority list, a lower priority device of the pair of incompatible devices; and
omitting the lower priority device from the compatible device set.

18. The network switch device of claim 14, wherein performing the compatibility assessment occurs upon detecting a connection of a new network switch device to the switch aggregation group during operation of the switch aggregation group.

19. The network switch device of claim 18, wherein performing the compatibility assessment comprises:
determining from the compatibility information, if the new network switch device is incompatible with any existing operating network switch devices in the set of network switch devices;
including the new network switch device in the compatible device set if the new network switch device is compatible with all of the existing operating network switch devices; and
omitting the new network switch device from the compatible device set if the new network switch device is incompatible with any of the existing operating network switch devices.

20. The network switch device of claim 14, wherein obtaining the respective device identifiers for the set of devices comprises reading the respective devices identifiers from the set of devices.
